(19) United States
(12) Patent Application Publication
(10) Pub. No.: US 2009/0171572 A1
(43) Pub. Date: Jul. 2, 2009

(54) Navigation Aid System

(76) Inventors: Clement Alteresco, Paris (FR); Marie-Caroline Lanfranchi, Paris (FR); Thierry Anselot, Paris (FR)

Correspondence Address: FULBRIGHT & JAWORSKI, LLP, 666 FIFTH AVE, NEW YORK, NY, 10103-3198, US

(21) Appl. No.: 12/227,919

(22) PCT Filed: May 25, 2007
(86) PCT No.: PCT/FR2007/051330

§ 371 Date: Feb. 20, 2009

(30) Foreign Application Priority Data
May 29, 2006 (FR) 0651937

(51) Int. Cl. G01C 21/34; G06F 17/30

(52) U.S. Cl. 701/209; 707/10; 707/E17.01

(57) ABSTRACT

The invention concerns a navigation aid system comprising beacons implanted proximate single points Pᵢ of a road network and at least one portable device, each of the beacons Bᵢ including a transmitter associated with a storage unit containing at least one single identifier of said beacon IBᵢ. Each of the portable receiver devices comprises an application for recording a destination D and for calculating an information message from the received identifier IBᵢ, of the previously received identifier IBᵢ₋₁, of the recorded destination D and a database recorded in a local storage unit. The database comprises only N different information parameters I_{i,n} for the Nᵢ road junctions associated with the single point Pᵢ, the application selecting the parameter I_{i,d} based on the recorded destination D. The information message is generated based on the identifier IBᵢ₋₁ and the information parameter I_{i,d}.

The present invention relates to the field of automated guidance.

The invention relates more particular to a system for the guidance of a pedestrian equipped with a cell phone, transmitting vocal or visual orientation information.

There are known GPS location systems in the prior art used to compute routes and guide users. Such an approach however cannot be used unless the user is situated in an environment compatible with the transmission of HF signals using the GPS network.

There is also the known Japanese patent JP2002310720 describing an information system for downloading a map into a cell phone. The use of this system also necessitates moving in an environment that enables signals to be propagated with the positioning network.

It is an aim of the present invention to overcome this drawback by proposing a solution that can be used in an underground network, for example the subway, using a portable apparatus such as a cell phone.

It is another aim of the invention to enable operation with a simplified portable apparatus having limited memory resources at its disposal.

It is yet another aim of the invention to enable the guidance of a visually impaired individual in a network such as the subway.

To this end, the invention in its broadest sense pertains to a orientation aid system comprising beacons implanted in proximity to single points Pᵢ of a transit system and at least one portable receiver device, each of the beacons Bᵢ including a transmitter associated with a memory containing at least one unique identifier IBᵢ of said beacon, each of the portable receiver devices comprising an application to record a destination D and to compute an information message from the identifier IBᵢ received, the identifier IBᵢ₋₁ previously received, the recorded destination D and a database recorded in a local memory, said database comprising only N different information parameters I_{i,n} for the Nᵢ route junctions associated with the single point Pᵢ, the application selecting the parameter I_{i,d} as a function of the recorded destination D, the information message being generated as a function of the identifier IBᵢ₋₁ and the information parameter I_{i,d}.

Advantageously, the system furthermore comprises at least one database server equipped with means for downloading into the local memory of a portable receiver device.

Preferably the server comprises means for selecting a sub-set of the database, as a function of the route chosen by the user.

According to one particular embodiment, the portable receiver equipment is constituted by a cell phone and said beacons communicate with the cell phones for a wireless link whose range is smaller than the distance from the nearest beacons.

According to one particular variant, said beacons comprise an autonomous power supply, the transmitter constantly transmitting the identifier IBᵢ.

According to a preferred mode of implementation, said messages are audio messages coming from a local database in which the possible messages are recorded.

According to one variant, said messages are graphic messages coming from a local database in which the possible messages are recorded.

According to one particular variant of an implementation, the application comprises a function of recording the identifier IBᵢ of the nearest beacon to a memory and a function of computing a route between a pre-determined point and, preferably, the point at which said beacon is implanted, and means for activating said function. The point of departure however is not necessarily the point at which the beacon is implanted.

According to another variant, the beacons of a transit system network have the same session identifier.

The present invention will be understood more clearly from the following description, made with reference to a non-exhaustive example of implementation illustrated by the appended drawings where:

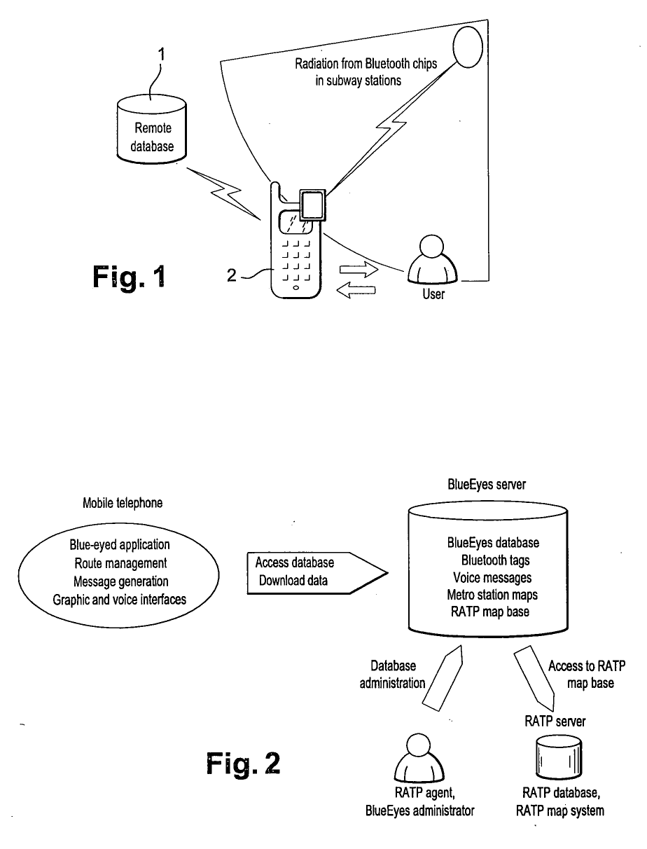

FIG. 1 is a functional diagram of a system according to the invention,

FIG. 2 is a functional diagram of an application according to the invention,

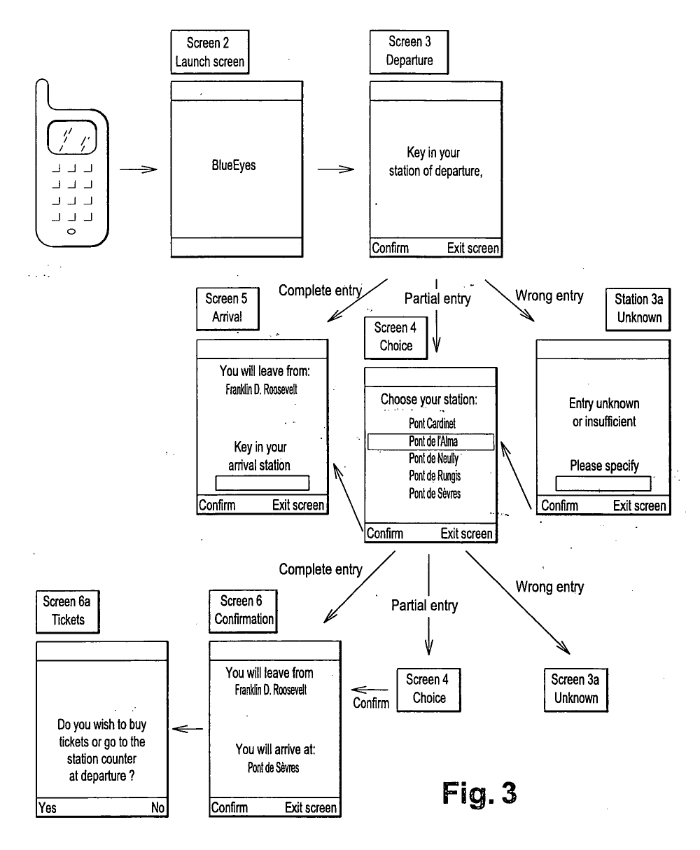

FIG. 3 represents the procedure for launching the application,

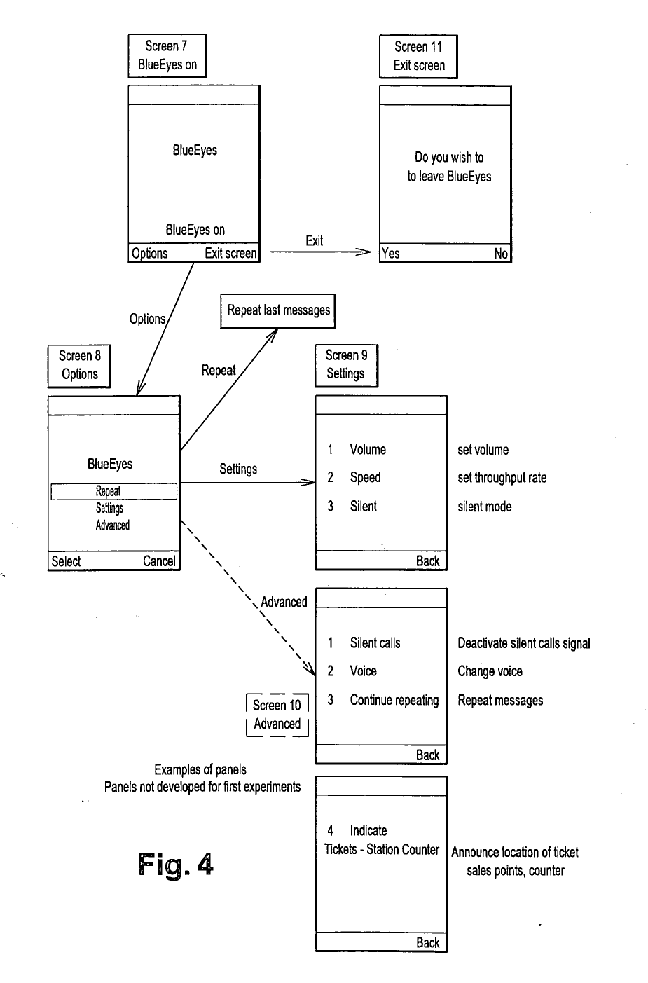

FIG. 4 represents the procedure for making settings in the application,

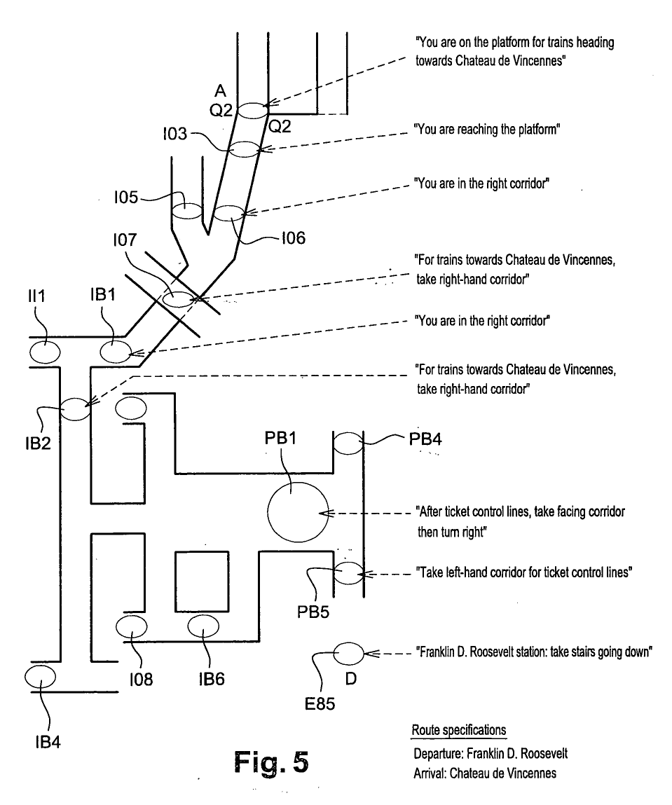

FIG. 5 represents the procedure for simulating the application on a complete path,

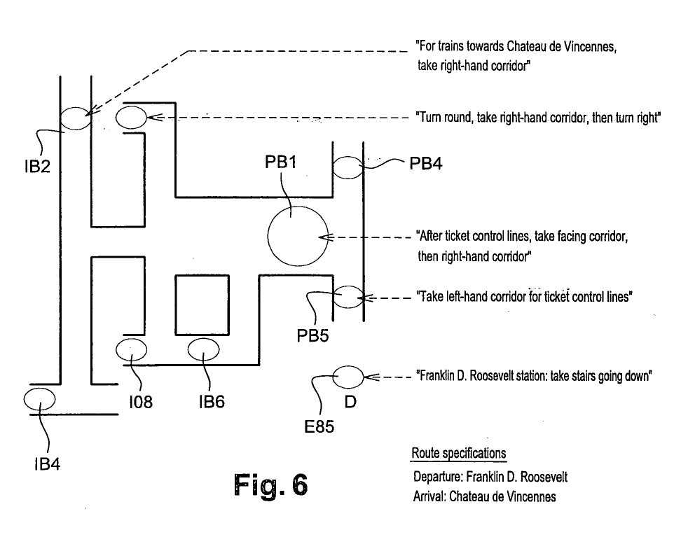

FIG. 6 represents the procedure for simulating the application with error management,

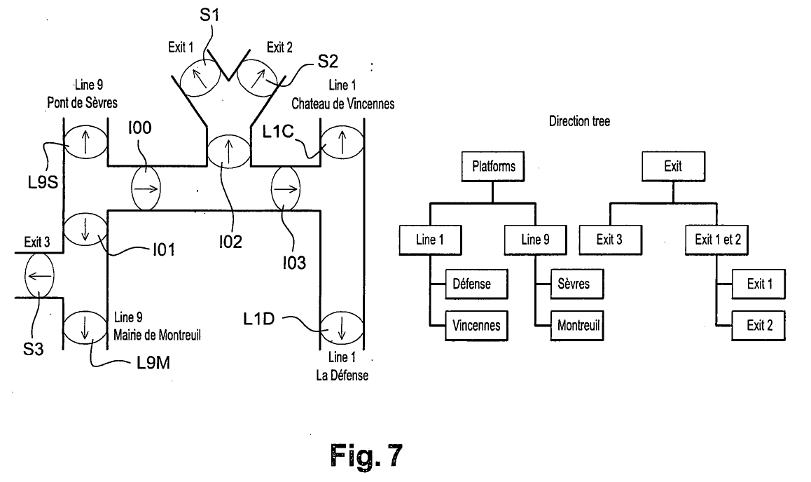

FIG. 7 represents an orientation scheme.

The invention provides a description here below, by way of an example, of a system of guidance in the subway for blind and visually impaired persons that can also be applied to tourism and other uses. The users are guided by an application on the mobile telephone: the telephone picks up the Bluetooth signal from markers distributed in the Metro stations and informs the user by a voice message on the directions to be taken.

The purpose of this system is to make the users' movements more fluid when they are travelling on known routes and to guide them over unknown routes: the voice interface informs the user of the directions to be taken, reassures him when he takes the right route and informs him when he makes a mistake.

The application enables the user to program his movements in advance (at home or in the street) and guides him from the entrance to the subway station up to his final destination.

The main advantage of the invention as compared with prior-art guidance solutions is that it can be used to re-orient a user who has lost his way by telling him how to get to his destination.

The system of the invention is aimed at visually impaired or blind users who have a good moving technique. The aim of this system is not to help them but to give them information in keeping with the information displayed in subway stations so as to increase their independence.

The users must know how to use a mobile telephone and if need be must have a voice system (Type Talks, or Mobile Speak) on their mobile telephone.

Functional Specifications

The system of the invention works on mobile telephones and accesses a remote database. The architecture of the system is described here below.

Technologies

The application is developed under Symbian OS, the operating system for mobile telephones.

The telephone accesses the remote database by GPRS and downloads the information needed (data on stations visited) on the user's mobile telephone. During movements in subway stations, the telephone detects the Bluetooth markers and communicates voice messages to the user by means of a wired ear-piece.

The markers are Bluetooth electronic chips adapted to people moving in urban environments. The detection of the markers by a mobile telephone is instantaneous. The markers work on batteries and their power consumption is limited in order to give them a highly satisfactory service life (two years without changing batteries). Furthermore, the battery level of the markers will always be retrieved by the application. The radiation of the markers is circular or conical and the rays can be modified by settings. Furthermore, the ergonomic features of the packages are designed so that they can be positioned discreetly and inaccessibly on a wall.

FIG. 1 is a functional diagram.

When the user launches the application and specifies his route, the application downloads all the data needed for guidance to his mobile phone (2): the database of the markers and messages from the stations visited, the map of the transport network, etc.

The user then goes to his subway station of departure and is taken charge of by the system. His telephone detects the markers whenever he comes into a radiation zone (at the instants ti). At each instant ti, the application computes the user's position and determines his orientation as a function of the previous marker: ti−1. Access to the database (1) in a room then makes it possible to determine the message to be given to the user.

The application therefore works step by step and makes real-time computations of the path to be indicated to the user. This therefore enables the system to guide the user in every situation: no path is computed in advance: any user who has lost his way can be retrieved by the system.

Furthermore, the application retrieves the battery levels of the tags encountered and notifies the server (as soon as the GPRS link is possible) when a tag reaches the critical level of 10% of its capacities.

Structure of the Database (1)

The database proper to the system can be used to respond to several types of queries, as illustrated in FIG. 2:
Determining the user's position at the instant ti, with the code of the detected Bluetooth marker being known;
Determining the user's orientation at the instant ti, the user's position at the instants ti−1 and ti being known;

Determining the message to be delivered to the user at the instant ti, his final destination being known along with his position and his orientation.

The database is formed by several tables:
The orientation tables which associate each pair of neighbouring markers with an orientation: 0/1;

| Beacon | Previous beacon | Orientation |
|---|---|---|
| I00 | L9S, I01 | 0 |
| I00 | O02, I03 | 1 |
| 103 | I00, I02 | 0 |
| 103 | L1C, L1D | 1 |
| ETC. | | |

The direction tables which list all the possible directions in a given station: line 1 direction A, line 1 direction B, line 1, exit 1, exit 2, etc and indicate the hierarchies in the form of a direction tree;
The message tables which associate the message to be delivered with each marker/direction pair in the case of an orientation 0. This message consists of a turn-round indication: Yes/No and a sentence (message code or pre-message). The orientation 1 is deduced simply by reversing the turn-round indication.

The lists of messages contain associations between the codes and the message sentences:

Example of Message Table

| Beacon | Direction | Turn-round | Message name |
|---|---|---|---|
| 100 | Exits 1 & 2 | No | G |
| 100 | Line 1 | No | F |
| 100 | Line 9 to Sèvres? | Yes | D |
| 100 | Line 9 Montreuil, | Yes | G |
| | Exit 3 | | |
| 103 | Line 1 Vincennes | No | G |
| 103 | Line 1 Défense | No | D |
| 103 | Exits 1 & 2 | Yes | D |
| 103 | Line 9, Exit 3 | Yes | F |
| ETC. | | | |

Example of Message Lists

| Name | Message |
|---|---|
| D | Take right-hand corridor |
| G | Take left-hand corridor |
| F | Take facing corridor |

Furthermore, the application will also have to manage information on the map of the subway system so as to guide a user from his station of departure up to his final destination. This information will be imported from the traditional databases of the transit network and managed by the system (with local downloading of the necessary data). This part of the database is not described here because it is not part of the functions tested by the experiments.

FIG. 3 shows the screens seen by the user when the invention is implemented.

The user guidance information can be rendered in different forms: voice messages in different languages, graphic messages, touch messages etc.

Voice Interface

This interface is described in the previous section: “structure and type of messages”. Whenever the user enters the field of a marker, a voice message is delivered to him to inform him of the direction to follow or confirm his direction. This interface could be adapted to several languages.

Graphic Interface

In order to propose a redundant or complementary service for the visually impaired, the application will display a symbol on the screen of the mobile telephone indicating the direction to be followed. Thus, a visually impaired user can move about using visual symbols and/or voice messages.

The application can be launched simply by clicking on the icon of the application in the main menu. Whenever the application is launched, the user must specify his stations of departure and arrival and state whether he wishes to be informed of the location of the ticket dispensers or that of the information desk.

The following scheme summarises the running of the operations:
Entry of the station of departure: the user is asked to key in the first letters of the name of the subway station (or a part of the name);
If the entry is wrong, i.e. if no station in the database corresponds to the entry or if the entry corresponds to an excessively large number of stations, the user is asked to correct or specify his entry;
If the entry corresponds to several stations (for example between two and five stations), the user is asked to go through the list of stations (using an up/down knob) and confirm his choice or return to the previous entry;
Entry of the station of arrival: same procedure as for the station of departure;
A screen then summarises the choices of the route (departure and arrival).

Finally, the application asks the user if he wishes to know the locations of the ticket dispenser and of the information office in his station of departure.

Setting Options and Parameters

At any time, when the application is in progress (immediately after it is launched or later in the station), the user can modify the parameters of the application or ask for the last message to be repeated. FIG. 4 illustrates the screens corresponding to the setting of the options and parameters:
To repeat the last message, press the green key twice (“Options>Repeat”);
To return to the menu: “Settings”, press the green key once, scroll down in the menu and press the green key again (“Options>Settings”);
To change the volume, return to the menu: “Settings” (“Options>Settings right hand arrow>Volume”) and move the knob rightwards (higher volume) or leftwards (lower volume);
To change the rate of flow of the messages, return the menu: “Settings”, go down one line (“Options>Settings>Speed”) and move knob rightwards (faster) or leftwards (slower);

To make the application silent, go to the menu: “Settings”, move down two lines (“Options>Settings>Silent”) and move the knob rightwards (silent or not silent);
To return to the menu: “Advanced”, press the green key once, go down two lines in the menu and press the green key again (“Options>Forward”).

Example of Use

FIG. 5 seeks to illustrate the working of the BlueEyes application in a concrete example. In this example, the user wishes to go from the station Franklin D Roosevelt to the station Nation (Line 1, in the direction of Chateau de Vincennes). The illustrated part corresponds to the movements of the user in the station Franklin D Roosevelt from the entrance No. 5 up to the platform of Line 1 in the direction of Chateau de Vincennes.

FIG. 6 illustrates the route taken by a user who has lost his way and is then re-directed by the system.

FIG. 7 shows an orientation scheme.

1-10. (canceled)

11. Orientation aid system comprising:
a plurality of beacons, each beacon placed in proximity of one of said plurality of single points of a transit system and each beacon comprising a transmitter and an associated memory containing at least one unique beacon identifier of said each beacon; and
at least one portable receiver device comprising an application module to record a destination D and to compute an information message from a beacon identifier IBᵢ received, a previously received beacon identifier IBᵢ₋₁, the destination D and a local database stored in a local memory of said at least one portable receiver device; and
wherein said local database comprises N different information parameters I_{i,n} for the Nᵢ route junctions associated with a single point Pᵢ, said application module operable to select a parameter I_{i,d} as a function of the destination D and said information message.

12. Orientation aid system of claim 11, further comprising at least one database server operable to download information to said local memory of said at least one portable receiver device.

13. Orientation aid system of claim 12, wherein said at least one server is operable to select a sub-set of the local database as a function of a route selected by a user.

14. Orientation aid system of claim 11, wherein said at least one portable receiver is constituted by a cell phone. and said plurality of beacons communicate with the cell phone over a wireless link.

15. Orientation aid system of claim 11, wherein each beacon comprise an autonomous power supply and the transmitter of said each beacon is operable to constantly transmit said beacon identifier IBᵢ.

16. Orientation aid system of claim 11, wherein said information message is a recorded audio message from said local database of said at least one portable receiver.

17. Orientation aid system of claim 11, wherein said information message is a stored graphic message transmitted from said local database of said at least one portable receiver.

18. Orientation aid system of claim 11, wherein said application module is operable to store a beacon identifier IB of a nearest beacon to said local memory and operable to compute a route between a pre-determined point and a point of departure.

19. Orientation aid system of claim 11, wherein said application module is operable to store a beacon identifier IB of a nearest beacon to said local memory and operable to compute a route between a pre-determined point and a single point of said nearest beacon.

20. Orientation aid system of claim 1, wherein each of said plurality of beacons of said transit system has a same session identifier.
